(19) United States
(12) Patent Application Publication
(10) Pub. No.: US 2003/0164899 A1
(43) Pub. Date: Sep. 4, 2003

(54) Multilingual video-transmitting/receiving system

(76) Inventor: Don S Lee, Ansan-city (KR)

Correspondence Address: NIXON & VANDERHYE, PC, 1100 N GLEBE ROAD, 8TH FLOOR, ARLINGTON, VA, 22201-4714, US

(21) Appl. No.: 10/363,778

(22) PCT Filed: Sep. 7, 2001
(86) PCT No.: PCT/KR01/01513

(30) Foreign Application Priority Data
Sep. 9, 2000 (KR) 2000-53722

(51) Int. Cl. H04N 7/08

(52) U.S. Cl. 348/484; 348/485

(57) ABSTRACT

A multilingual video-transmitting/receiving system includes multiplexing means for embedding a plurality of audio information channels in each of a plurality of video information channels and generating integral video signal, a plurality of subscriber receiving means for receiving the integral video signal, selecting one of video information channels from the integral video signal, and selecting one of the audio information channels embedded in the selected video information channel.

### FIELD OF THE INVENTION

The present invention relates to a television broadcasting system and, in particular, to a multilingual video-transmitting/receiving system capable of carrying a plurality of video information, each having multilingual audio information, on a broadcasting channel such that any of the video information and any of the audio information embedded in the video information are selected at a subscriber receiver.

### BACKGROUND OF THE INVENTION

There has been much research done on satellite communications all around world and recently the satellites are used for remote videoconference and local television broadcasting.

The satellite communication has many advantages of broadband data transmission so as to be able to provide high quality television broadcasting and cover all the regions on the earth or localize the broadcasting region using scramble signal.

Even though the satellite broadcasting can cover the entire world, it has a drawback in that audio signal distributed to a region where a current language differs from the language of the audio signal, the audio signal language should be simultaneously translated into the current language of the region or a universal language caption service should be provided.

### SUMMARY OF THE INVENTION

The present invention has been made in an effort to solve the above problems.

It is an object of the present invention to provide a multilingual video-transmitting/receiving system capable of carrying a plurality of video information, each video information channel having a plurality of audio information channels, on a broadcasting channel such that one kind of the audio information is selectively received together with the corresponding video information by a video receiver.

To achieve the above object, the multilingual video-transmitting/receiving system of the present invention comprises multiplexing means for embedding a plurality of audio information channels in each of a plurality of video information channels and generating integral video signal, a plurality of subscriber receiving means for receiving the integral video signal, selecting one of video information channels from the integral video signal, and selecting one of the audio information channels embedded in the selected video information channel.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram illustrating a multilingual video-transmitting/receiving system according to the preferred embodiment of the present invention;

FIG. 2 is a schematic view illustrating a transmitter of the multilingual video-transmitting/receiving system according to another embodiment of the present invention; and

FIG. 3 is a schematic view illustrating a receiver of the multilingual video-transmitting/receiving system according to another embodiment of the present invention.

FIG. 4 is a schematic view illustrating a receiver of the multilingual video-transmitting/receiving system according to another embodiment of the present invention.

### DETAILED DESCRIPTION OF THE EMBODIMENTS

A preferred embodiment of the present invention will be described hereinafter with reference to the accompanying drawings.

The present invention provides a multilingual video-transmitting/receiving system capable of carrying a plurality of video information, each being embedded with multilingual audio information, on a broadcasting channel. For example, in cases a broadcasting service is provided to the entire world or a few designated states, and it is required to provide broadcasting service to clients, lodged in a hotel, from a plurality of countries, a multilingual video channel gives people resided in different countries and lodged at different room of the hotel an option so as to select a language.

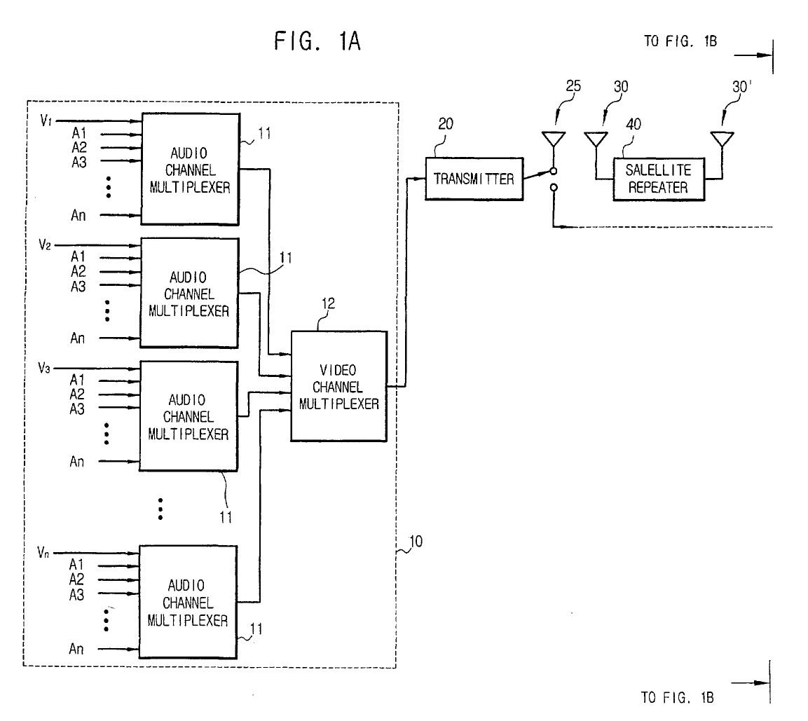

FIG. 1 is a block diagram illustrating a multilingual video-transmitting/receiving system of the present invention.

As shown in FIG. 1A and FIG. 1B, the multilingual video-transmitting/receiving system of the present invention comprises multiplexing means 10, a transmitter 20 having an antenna 25, a satellite repeater 40 having transceivers 30 and 30′, a plurality of subscriber receiving means 50 having an antenna 25′.

The multiplexing means 10 comprises a plurality of audio channel multiplexers 11 for embedding a plurality of languages of audio information A1, A-2, . . . , and An in a plurality of kinds of video information V1, V2, . . . , and Vn, and a video channel multiplexer 12 for carrying the video information in a broadband channel.

The subscriber receiving means 50 comprises a high-frequency receiver 51 for receiving the broadcasting signal, a video channel demultiplexer 52 connected to the high-frequency receiver 51 for demultiplexing the video channels from the broadcasting signal, a first switch SW1 connected to the video channel demultiplexer 52 for select any of the demultiplexed video channels, a audio channel demultiplexer 53 for demultiplexing the audio channels embedded in each video channel, a second switch SW2 connected to the audio channel demultiplexer 53 for select any of the demultiplexed audio channels, and a plurality of audio/video coordinators 54 for combining the audio channel selected by the second switch SW2 with the video channel selected by the first switch SW1. Each audio/video coordinator 54 can be connected to a television set or earphone. The first and second switches SW1 and SW2 can be mechanical switches, electromagnetic switches, or code switches.

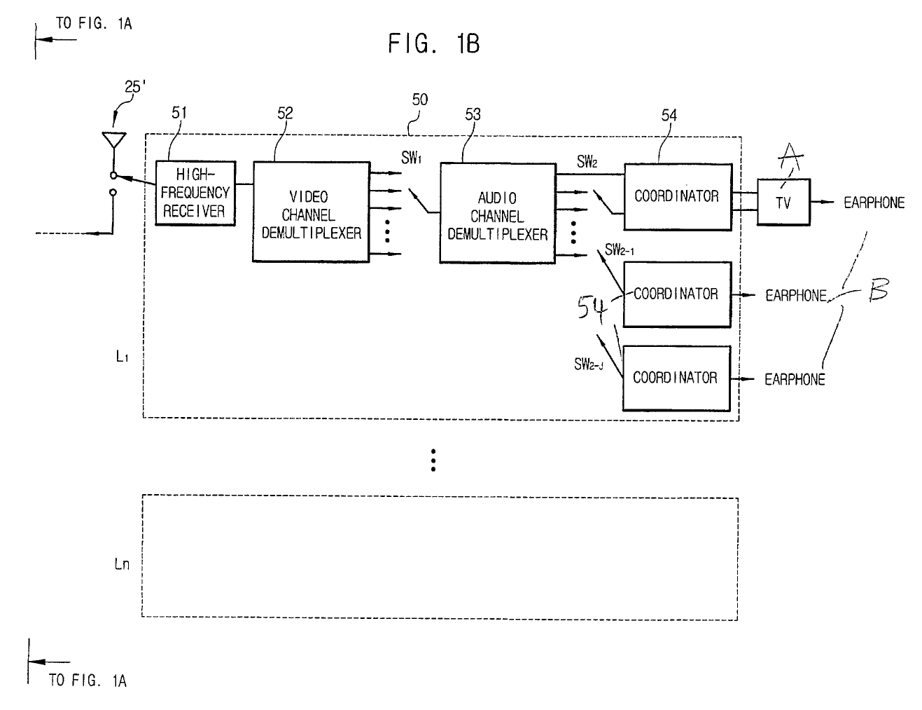

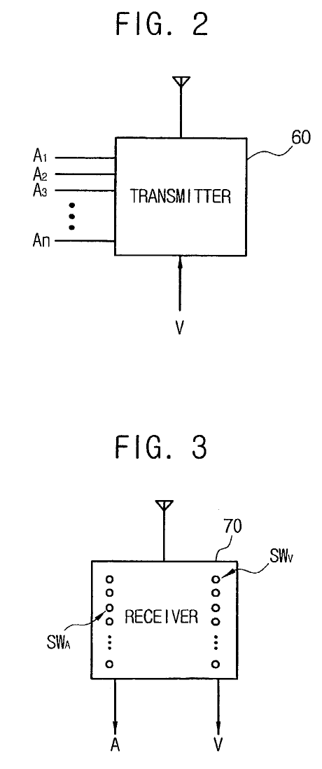

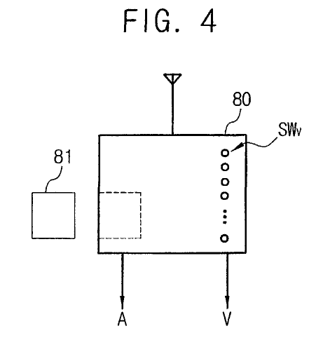

FIG. 2 shows a transmitter of the multilingual video-transmitting/receiving system according to a second embodiment of the present invention. FIG. 3 shows a receiver of the multilingual video-transmitting/receiving system according to a third embodiment of the present invention, and FIG. 4 shows a receiver of the multilingual video-transmitting/receiving system according to a fourth preferred embodiment of the present invention.

As shown in FIG. 2, the transmitter 60 embeds a plurality of audio information A1, A2, A3, . . . , An of different audio channels in a video information V and then transmits the video information into the air through the antenna.

As shown in FIG. 3, the receiver 70 receives a plurality of the video information each having the plurality of audio information and then any of the video information is selected by video selection switch SW_{V} and any of the audio information embedded in the selected video information is selected by an audio selection switch WS_{A}.

As shown in FIG. 4, the receiver 80 receives a plurality of the video information each having the plurality of audio information and then any of the video information channels is selected by video selection switch SW_{V}, and any of the audio information channels embedded in the video information is filtered by an audio information filter 81 installed in the receiver 80.

The operation of the above-structured multilingual video-transmitting/receiving system will be described hereinafter.

Each audio channel multiplexer 11 of the multiplexing means 10 embeds a plurality of languages of audio information A1, A2, . . . , An in respective video information V1, V2, V3, . . . , Vn and then sends the video information to the video channel multiplexer 12. The video channel multiplexer 12 carries all the video information streams from the audio channel multiplexers 11 on a broadband channel and then sends the multiplexed video information to the transmitter 20. The transmitter 20 transmits the video information to the satellite repeater 40 through the antenna 25. The satellite repeater 40 receives the video information through the transceiver 30 and broadcasts the same into the air through another transceiver 30′. The multilingual video information can be transmitted from the transmitter 20 to the subscriber receiving means through wireless channel, coaxial cables, or fibre optics without using the satellite repeater.

The broadcasted video information is received by the high-frequency receiver 51 of the subscriber receiving means 50 through the antenna 25′ and then demultiplexed by the video channel demultiplexer 52. Next, any of the video channels is selected by the first switch SW1. The selected video channel contains the plurality of audio channels such that the audio channels of the video channel are demultiplexed by the audio channel demultiplexer 53 and then any of the audio channels is selected by the second switch SW2. The video and audio channels selected by the first and second switches SW1 and SW2 are combined by one of the audio/video coordinators 54 and outputted through a television or an earphone.

The subscriber receiving means 50 is provided with a plurality of the audio/video coordinators and each audio/video coordinator has an output interface with a tuner for manipulating the second switch such that a subscriber can select any of the languages of the audio channels.

Since the operations of the transmitter 60 and receiver 70 in FIG. 2 and FIG. 3 are similar to the operations of the multiplexing means 10 and the subscriber receiver 50, the operation details of the transmitter 60 and receiver 70 are not described.

Regarding FIG. 4, the receiver 80 receives the broadcasting signal, then one video information having a plurality of audio information is selected by the switch SW_{V}, and specific one of the plurality of audio information filtered by the filter 81. Accordingly, the receiver 80 can provide video information in just one kind of language audio information.

As described above, in the multilingual voice-embedded video-transmitting/receiving system of the present invention, the multiple language audio information is embedded in the video information such that the subscribers can watch videos with a language of any of the audio information regardless to where he/she is located in the world.

Also, in case of teleconference using the multilingual voice-embedded video-transmitting/receiving system, a plurality of audio channels are provided the communication can be interactively performed without translators.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A multilingual video transmitting/receiving system comprising:
multiplexing means for embedding a plurality of audio information channels in each of a plurality of video information channels and generating integral video signal;
a plurality of subscriber receiving means for receiving the integral video signal, selecting one of video information channels from the integral video signal, and selecting one of the audio information channels embedded in the selected video information channel; and
a satellite repeater for receiving the integral video signal and broadcasting the same in the air.

2. A multilingual video transmitting/receiving system of claim 1 wherein the multiplexing means comprises:
a plurality of audio channel multiplexers, each embedding a plurality of audio information channels in a video information channel;
a video channel multiplexer for multiplexing the video information channels and generating the integral video signal.

3. A multilingual video transmitting/receiving system of claim 1 wherein the subscriber receiving means comprises:
a high-frequency receiver for receiving the integral video signal;
a video channel demultiplexer for demultiplexing the integral video signal from the high-frequency receiver into the video information channels;
an audio channel demultiplexer for demultiplexing the audio channels in each of the demultiplexed video information;
a plurality of audio/video coordinators each for combining a video channel and any of the audio channels;
a first switch for distributing the demultiplexed video information channels to the corresponding audio/video coordinators and the audio channel demultiplexer; and
a second switch for distributing the demultiplexed audio information channels to the corresponding audio/video coordinators.

4. A multilingual video transmitting/receiving system of claim I wherein the subscriber receiving means comprises:
a high-frequency receiver for receiving the integral video signal;
a video channel demultiplexer for demultiplexing the integral video signal from the high-frequency receiver into the video information channels;
a first switch for selecting any of the demultiplexed video information channels;
an audio channel demultiplexer for demultiplexing the audio channels in each of the demultiplexed video inforamtion;
a second switch for selecting any of the demultiplexed audio information channels; and
a plurality of audio/video coordinators each for combining the video information channel and any of the audio channels;

5. A multilingual video transmitting/receiving system of claim 3 wherein each audio/video coordinator is provided with an output interface for connecting television or earphone and a pair video and audio channel tuners so as to select a video and audio channels.

6. A multilingual video transmitting/receiving system of claim 4 wherein each audio/video coordinator is provided with an output interface for connecting television or earphone thereto and a tuner connected to the second switch so as to select an audio channel of a specific language by manipulating the tuner.

7. A multilingual video receiver comprising a video channel switch for selecting any of video channels from an integral video channel received through an antenna and a channel filter for filtering specific audio channel among audio channels embedded in each video channel.
